(19) United States
(12) Patent Application Publication
(10) Pub. No.: US 2008/0183588 A1
(43) Pub. Date: Jul. 31, 2008

(54) METHOD AND SYSTEM FOR VALIDATING CONSUMER PREFERENCES AND PURCHASE ITEMS AT POINT OF SALE

(75) Inventors: Dakshi Agrawal, Monsey, NY (US); James R. Giles, Yorktown Heights, NY (US); Kang-Won Lee, Nanuet, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/668,710

(22) Filed: Jan. 30, 2007

(51) Int. Cl. G06Q 30/00

(52) U.S. Cl. 705/16

(57) ABSTRACT

A method for linking consumer preferences and purchase decisions with point-of-sale systems, wherein the method includes: defining consumer preferences in a third-party system; obtaining consumer preference identification at a point of purchase; providing information about purchase items and the consumer preference identification to the third-party validation system; validating that the items being purchased do not violate the consumer preferences; and wherein based on the validating providing notification to the point-of-sale system.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to point of sale payment systems, and more particularly to systems and methods for providing information about consumer preferences and optionally enforcing those preferences.

2. Description of the Related Art

Consumers have many types of preferences for products and services that are purchased by them or their minor children. In some cases, there are preferences related to safety concerns, such as avoiding ingredients like nuts, wheat, and phenylalanine in response to food allergies. In other cases, there are classes of products that parents would like their children to avoid, such as foods with trans-fats as a way to promote healthy eating, or video games, movies, and CDs with certain ratings as a way to enforce values. Other examples are cultural or religious preferences that restrict the products that consumers buy. Such consumers make extra effort to buy food products that are acceptable to their belief and background by for example avoiding pork or only consuming kosher foods. Consumers may be sensitive to animal cruelty and may only want to buy certain types of products, e.g. cage-free eggs, cosmetics without animal testing. As a final example, consumers may have preferences that help them stay within a budget.

To manage these preferences without assistance requires substantial effort and discipline. For example, in the case of food allergies, consumers must spend considerable time reading the ingredients of each product to make sure that they have not inadvertently purchased and consumed unwanted or even dangerous items. The only way that parents can be absolutely sure that items are not purchased by their children, is to not let them go into stores (or online) unattended or to make certain they have no means of buying anything without the parents present.

What is needed, is a way for consumers to describe certain preferences, for example to at least be warned if a product contains an ingredient like nuts, and then at retail be notified if any items being purchased violate the preferences. As an extension, such a system could block the sale of items that do not conform to the preferences, e.g., purchase of fast-food items at dinnertime. While such a system has obvious benefits and advantages to consumers and could be offered to enhance consumer satisfaction, it also has a commercial advantage of helping consumers and their children behave responsibly, for example in diet choices.

Presently, databases kept by pharmacies warn consumers about medication allergies and adverse medication interactions. However, these pharmacy systems are focused only on medicines and their interactions, are limited to a particular pharmacy network, and suffer from not being aware of medicines purchased from other pharmacy networks. In addition, such systems have little personalization beyond specific drug allergies—a single list of the interactions to avoid is maintained by the pharmacies and the pharmacy advice is dispensed only according to this list, without additional input by the consumer.

To overcome these serious drawbacks, an ideal system needs to not only warn and optionally block a purchase when preferences are violated, but it also needs to be universal, personalized, secure, privacy-preserving, and providing correlation across multiple items and purchase instances over a span of time. In particular, the system needs to be universal, so that any store is able to check the preferences and match them against the items being purchased. It needs to be personalized, in that the consumer should be able in control of the preferences to fit personal and unique needs. An ideal system also needs to be secure in that it will protect preferences from being changed or overridden. For a variety of reasons, many consumers will want such a system to maintain their privacy because it could reveal sensitive information like medical conditions, values, and targeted marketing demographics. Finally, it needs to provide correlation over multiple purchases over a span of time, so that it is possible to set preferences related to frequency of purchases.

### SUMMARY OF THE INVENTION

A method for linking consumer preferences and purchase decisions with point-of-sale systems, wherein the method includes: defining consumer preferences in a third-party system; obtaining consumer preference identification at a point-of-sale; providing information about purchase items and the consumer preference identification to the third-party validation system; validating that the items being purchased do not violate the consumer preferences; and wherein based on the validating providing notification to the point-of-sale system.

A method for linking consumer preferences and purchase decisions with a point-of-sale systems including: defining consumer preferences in a consumer-controlled device; gathering the preferences from the consumer-controlled device; providing information about purchase items and the consumer preferences to a validating device; wherein the validating device validates that the purchase items do not violate the consumer preferences; and providing notification to the point-of-sale system regarding the result of validating the purchase item.

A system for linking consumer preferences and purchase decisions with point-of-sale systems; wherein the system includes computing devices and a network; wherein the computing devices further include at least one of the following: computer servers; mainframe computers; desktop computers; and mobile computing devices; and wherein at least one of the computing devices is configured to execute electronic software that manages the consumer preferences and purchase decisions with point-of-sale systems; and wherein the electronic software is resident on a storage medium in signal communication with at least one of the computing devices; and wherein at least one of the computing devices is in signal communication with the network; and wherein the network further includes at least one of the following: local area network (LAN); wide area network (WAN); a global network; the Internet; an intranet; wireless networks; and cellular networks; and wherein the electronic software validates that items being purchased do not violate the consumer preferences; and the consumer is notified based on the electronic software validation if consumer preferences are not being met at the point-of-sale system.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a system and method for providing information about consumer preferences and optionally enforcing those preferences at the point of sale, while preserving the consumer's privacy of information.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a generic system for linking consumer preferences, information about services and products purchased, context information, payment systems, and historical purchase information to help support consumer purchase decisions according to an embodiment of the invention.

FIG. 2 illustrates a system where consumer preferences are maintained by the consumer, and only the preference analysis services are provided by the third party according to an embodiment of the invention.

FIG. 3 illustrates a system where customer preferences are maintained and analyzed by a third party according to an embodiment of the invention.

FIG. 4 illustrates a system where the customer maintains customer preferences and preference analysis is also done on a consumer-controlled device according to an embodiment of the invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a system and method for con-elating consumer preferences, product information, and purchase history to help support consumer purchase decisions at the point of sale. It also provides a mechanism for a guardiai's preferences for purchases made by a dependent to be honored. Finally, it provides a system and method for providing the service universally, without storing preferences within any given retailer's information technology infrastructure.

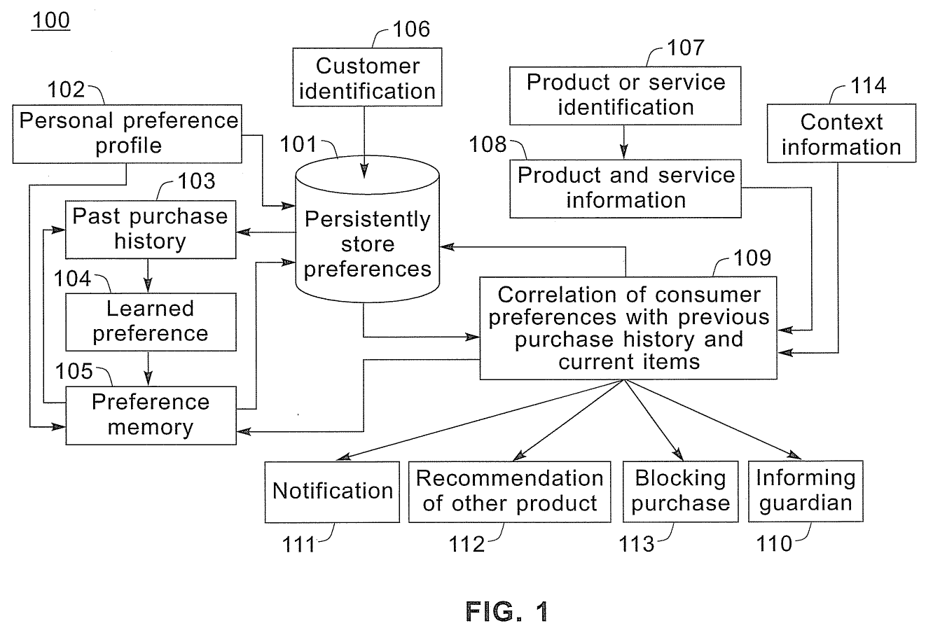

FIG. 1 illustrates a flow diagram 100 for the system linking consumer preferences, information about services and products purchased, context information, payment systems, and historical purchase information to help support consumer purchase decisions. Note that different embodiments of the invention can be realized by executing different portions of these flows on different systems and devices that may be under the control of customer, retailer or a third party. Examples of support might be to warn consumers of potentially dangerous ingredients or interactions or to control purchases made by minors. The first component of the system is the creation of a personal preference profile 102. Depending on the embodiment, this preference profile could be stored under the consumer's control in for example a personal preference memory 105. The preference profile can also be stored in remote preference storage that is maintained by a third party 101. The preference profile can be set and by analyzing past purchase history 103 and learning new preferences 104. In addition, consumer preferences can be selected from pre-arranged menus of preferences, such as for weight conscious customers, for diabetes patients, and for minors or dependents.

At the time of purchase, the product or service identification is determined 107 by, for example, reading a barcode, radio frequency identification, or visual recognition. Attributes of the product or service, such as ingredients, manufacturer, point of origin, or nutritional information are retrieved 108. The retrieval of attributes can be done as part of the identification 107, or by looking up the product information based on the product or service identification in a local or centralized database. Context information such as the location of purchase, name of the business, time of day, and provider of the service are collected 114. Optionally, the consumer information is read 106 by examining a smart card, RFID, biometrics, or credit card information. This consumer information 106 can be used to lookup consumer preferences stored in persistent storage. Alternatively, the consumer, from the information stored in the personal preference memory 105, can provide the personal preferences.

With the personal preference information 105, context information 114, and information about the products and services 108 that are intended to be purchased, the information is correlated 109 with the preferences and a determination is made to see if the preference rules warrant notification 111, recommending another product 112, blocking the purchase 113, or informing a guardian of a purchase attempt 110. The consumer purchase information is optionally fed back for storage in the personal preference store 105 or third party preference store 101.

The correlation 109 can take into account multiple purchases over a period of time. For example, a guardian may only allow a dependent to have five trips to a fast food restaurant each month, or not allow trips during dinner hours, or may require that only certain menu items or menu items with certain nutritional characteristics may be purchased. The personal preference memory 105 may be in the form of a smart card that is used by the dependent to male purchases, or the dependent's credit card can be used as a key to unlock persistently stored preferences.

A key aspect of the persistent preference store 101 is that it is not under the control of a given retailer. Rather, a third party controls it so that the consumer's preferences are kept private and so that the preferences can be correlated across purchases regardless of where they are made. The persistent store may also be eliminated in favor of only using the consumer controlled personal preference memory 105. In this way, the consumer maintains even more privacy for the preference data. A device controlled by the consumer, so that the retailer never has access to the preference information, may do the correlation of consumer preferences.

Another key aspect of the invention is that the no additional information technology is required to be added to the place of purchase. The storage of preferences and validation can be done remotely without the need for additional equipment, especially if the consumer is identified with nearly ubiquitous credit cards.

There are many possible embodiments for the invention. In some embodiments, consumer preferences are embedded on a computer-readable device such as a bar-coded or RFID card. In other embodiments, consumer preferences are stored in one or more network accessible repositories and are accessed when a consumer provides an identifier such as a RFID tag, an identifier encoded as a barcode, or the identification information such as credit card account number stored on a credit card.

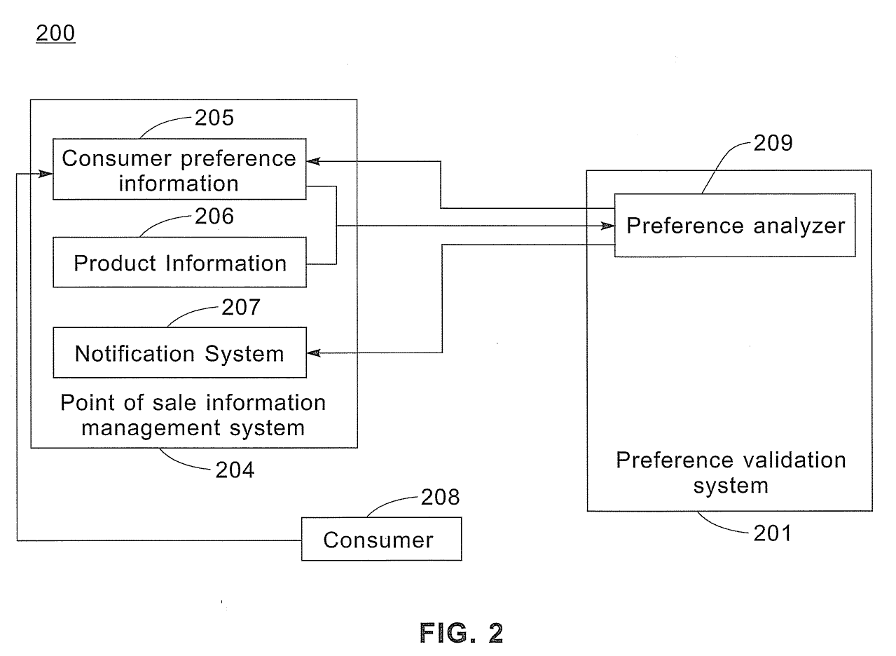

FIG. 2 illustrates a first embodiment 200 where the consumer information is stored in a computer readable device by the consumers. At the time of purchase, the consumer 208 presents the consumer preference information 205 to the point of sale information system 204 by, for example, allowing a bar-code reader to scan the consumer preferences encoded as a bar-code or by directly entering preferences at a terminal for a single transaction. The product and service information 206 is provided along with the consumer preference information 205 to a preference analyzer 209 of a third-party preference validation system 201. The preference checking may be done at any time during the shopping transaction including: when products are selected, while waiting in line, or while placing items in the cart. For example, preference checking at the time of product selection can be done by having an RFID scanner or barcode reader available where products are selected or can be done in online shopping by checking the preferences when items are placed in an on-line cart. Product information 206 attributes such as ingredients could be directly obtained from the product, or could be accessed over a network or in a local database based on a product identifier such as a UPC code. After analyzing the preferences, the preference analyzer optionally updates the consumer preference information 205 with details of the purchases and provides notifications 207 to the consumer with warnings or to the point of sale equipment to block purchase if warranted due to guardian preferences or liability concerns. The notification may be a display or a written notification on a receipt for example. Examples of display devices that a customer may carry include cell phones, smart phones, personal digital assistants (PDA), portable computers, etc.

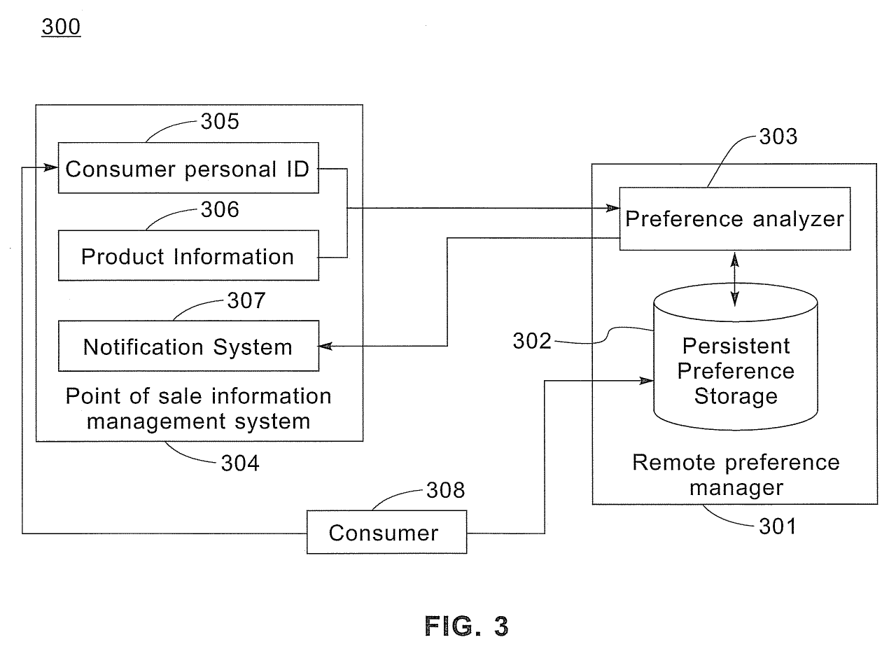

FIG. 3 illustrates a second embodiment of a system 300 for linking preferences and purchase decisions to payment equipment whereby consumer preferences and purchase history are stored and evaluated by a third-party system. Before making any purchases, a consumer 308 provides or updates already existing preference information with a third-party preference persistent preference storage 302. At the time of purchase, the consumer 308 presents a consumer personal identification 305 to the point of sale information system 304 by, for example, presenting a credit card or by allowing an RFID to be scanned. The product and service information 306 is provided along with the consumer personal identification 305 to a preference analyzer 303 of a third-party preference validation system 301. The consumer identification 305 and product information 306 is used to lookup preferences and purchase history stored in the persistent preference storage 302 so that the preference can be analyzed. As in the first embodiment, the preference checking may be done at any time during the shopping transaction, including when products are selected, while waiting in line, or while placing items in the cart. For example, preference checking at the time of product selection can be done by having an RFID scanner or barcode reader available where products are selected or can be done in online shopping by checking the preferences when items are placed in an on-line cart. Product information 306 attributes such as ingredients could be directly obtained from the product, or could be accessed over a network or in a local database based on a product identifier such as a UPC code. After analyzing the preferences, the preference analyzer 303 optionally updates the consumer preference information 302 with details of the purchases for additional purchase history and provides notifications 307 to the consumer with warnings or to the point of sale equipment to block purchase if warranted due to guardian preferences or liability concerns. The notification may be a display or a written notification on a receipt for example.

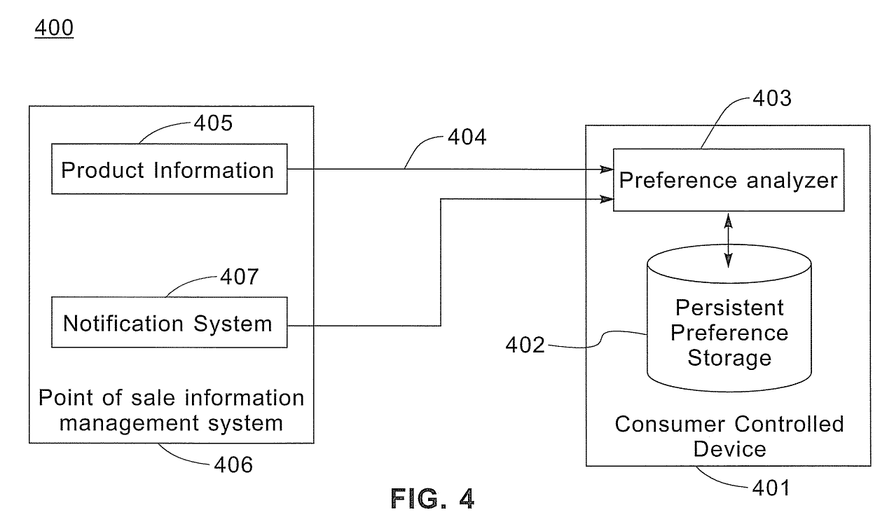

FIG. 4 illustrates a third embodiment of a system 400 for linking preferences and purchase decisions to payment equipment whereby consumer preferences and purchase history are stored in a consumer controlled device 401 and are also evaluated by the consumer controlled device 401. Before making any purchases, a consumer provides or updates already existing preference information in the persistent preference storage 402. At the time of purchase, the point of sale information system 406 provides the consumer controlled device 401 product information via a module 405 that produces this information. This information may consist of product IDs, or other detailed information on products, such as ingredients, place of manufacture, date of manufacture etc. After receiving the product information, the preference analyzer 403 on consumer controlled device 401, fetches any further product information as necessary to analyze preferences. After the product information is available, it validates the products to be purchased with preferences. As in the first embodiment, the preference checking may be done at any time during the shopping transaction, including when products are selected, while waiting in line, or while placing items in the cart. For example, preference checking at the time of product selection can be done by having an RFID scanner or barcode reader available where products are selected or can be done in online shopping by checking the preferences when items are placed in an on-line cart. Product information attributes such as ingredients could be directly obtained from the product, or could be accessed over a network or in a local database in the consumer controlled device 401 based on a product identifier such as a UPC code. Additional product information can be downloaded in the consumer controlled devices 401 via various communication means such as by connecting consumer controlled devices 401 to a computer and downloading product information from Internet sites providing such information. After analyzing the preferences, the preference analyzer 403 optionally updates the consumer preference information 402 with details of the purchases for additional purchase history and provides notifications to the notification system 407 with warnings or to the point of sale equipment to block purchase if warranted due to guardian preferences or liability concerns. The notification may be a display or a written notification on a receipt for example. It should be noted that interaction between consumer controlled device 401 and point of sales information management system 405 could either be through a contact less system such as prevalent in some smart cards today, or through a contact system such as traditional ATMs where a card is inserted in an ATM machine. Point of sale information management system may include not only the cash registers, but also other equipment such as shopping cards, smart aisles, etc.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for linking consumer preferences and purchase decisions with point-of-sale systems, wherein the method comprises:
defining consumer preferences in a third-party system;
obtaining consumer preference identification at a point-of-sale;
providing information about purchase items and the consumer preference identification to the third-party validation system;
validating that the items being purchased do not violate the consumer preferences; and
wherein based on said validating providing notification to the point-of-sale system.

2. The method of claim 1, wherein the notification comprises:
displaying information in a visual manner on a display device.

3. The method of claim 2, wherein the displaying of information is facilitated by at least one of the following: a device a customer carries; or a cell phone; or a smart phone; or a PDA; or a portable computing device.

4. The method of claim 1, wherein the notification comprises:
providing auditory cues.

5. The method of claim 1, wherein the notification comprises:
printed information.

6. The method of claim 4, wherein said printed information is presented to a consumer on a receipt.

7. The method of claim 1, wherein based on a violation of consumer preferences the sale of the violating item is blocked.

8. The method of claim 1, wherein the consumer preference is set by a guardian to control the purchases of a dependent.

9. The method of claim 1, wherein consumers historical purchase information is kept by the third-party system and is used in the validation of consumer preferences.

10. The method of claim 1, wherein obtaining consumer preference identification is facilitated by reading a magnetically encoded strip.

11. The method of claim 9, wherein obtaining consumer preference identification is facilitated by reading a magnetically encoded strip on a card.

12. The method of claim 1, wherein obtaining consumer preference identification is facilitated by reading a barcode.

13. The method of claim 1, wherein obtaining consumer preference identification is facilitated by reading a smartcard with radio frequency transmission.

14. The method of claim 1, wherein the providing information about purchase items is facilitated by at least one of the following: by reading a product barcode; or by reading a RFID tag; or by looking the information up in a database; or by reading the product information directly from a products packaging.

15. The method of claim 1, wherein the validating occurs when a customer places an item in a shopping cart.

16. The method of claim 1, wherein the validating occurs at the point of payment.

17. The method of claim 1, wherein the consumer preference can be selected from a pre-arranged menu of preferences.

18. A method for linking consumer preferences and purchase decisions with a point-of-sale systems comprising:
defining consumer preferences in a consumer-controlled device;
gathering the preferences from the consumer-controlled device;
providing information about purchase items and the consumer preferences to a validating device;
wherein the validating device validates that the purchase items do not violate the consumer preferences; and
providing notification to the point-of-sale system regarding the result of validating the purchase item.

19. The method of claim 18, wherein the defining of consumer preferences is facilitated by at least one of the following:
storing the consumer preferences in a RFID device; or
storing the consumer preferences in a machine readable barcode; or storing the consumer preferences in a smart card device.

20. A system for linking consumer preferences and purchase decisions with point-of-sale systems, the system comprising;
computing devices;
a network;
wherein the computing devices further comprise at least one of the following:
computer servers;
mainframe computers;
desktop computers; and
mobile computing devices; and
wherein at least one of the computing devices is configured to execute electronic software that manages the consumer preferences and purchase decisions with point-of-sale systems; and
wherein the electronic software is resident on a storage medium in signal communication with at least one of the computing devices; and
wherein at least one of the computing devices is in signal communication with the network; and
wherein the network further comprises at least one of the following:
local area network (LAN);
wide area network (WAN);
a global network;
the Internet;
an intranet;
wireless networks; and
cellular networks; and
wherein the electronic software validates that items being purchased do not violate the consumer preferences;
the consumer is notified based on the electronic software validation if consumer preferences are not being met at the point-of-sale system; and
wherein consumer preferences are stored in a third-party system or in a consumer-controlled device.
